(19) United States
(12) Patent Application Publication
(10) Pub. No.: US 2019/0180318 A1
(43) Pub. Date: Jun. 13, 2019

(54) SYSTEMS AND METHODS FOR UTILIZING MACHINE-READABLE CODE IN IMAGE DATA FOR TRACKING DATA SHARING

(71) Applicant: Facebook, Inc., Menlo Park, CA (US)

(72) Inventors: Evan Lee Chen, Menlo Park, CA (US); Yinshi Zhang, Hayward, CA (US)

(21) Appl. No.: 15/839,991

(22) Filed: Dec. 13, 2017

(51) Int. Cl. G06Q 30/02; G06Q 50/00; G06K 7/14

(52) U.S. Cl. CPC G06Q 30/0246; G06Q 30/0277; G06K 7/1417; G06Q 50/01

(57) ABSTRACT

The disclosed computer-implemented method for utilizing machine-readable code in image data for tracking data sharing may include (1) receiving, by a target computing device from a source computing device, image data in a graphical user interface, (2) identifying, by the target computing device, machine-readable code embedded in the image data, and (3) determining, by the target computing device, based on the embedded machine-readable code, one or more tracking metrics associated with sharing the image data. Various other methods, systems, and computer-readable media are also disclosed.

### BACKGROUND

Various client applications on client computing devices traditionally include data sharing functionality to enable the sharing of content between users. For example, a client application for a social media and social networking service may enable a user to share text messages, photographs, video clips, and/or other content with one or more other users utilizing the same or a similar client application, for viewing in a graphical user interface. In some instances, third parties, such as advertisers, may develop content that may be shared among multiple users. For example, an advertiser selling shoes may display an ad for consumption within a social networking service platform and may wish to track the number of users viewing the ad as the ad is shared among multiple users.

Utilizing traditional methods of content tracking, when an ad is shared with another user of a client application, the receiving client application or an external server application may need to execute external program code (e.g., via an application plug-in) to determine various metrics such as whether the ad has been viewed by a user of the receiving client application. This approach may incur a resource cost in the form of increased processing and memory resources for a client computing device and/or a server utilized to execute the external code needed to determine various ad metrics.

### SUMMARY

As will be described in greater detail below, the instant disclosure describes utilizing machine-readable code in image data for tracking data sharing by identifying machine-readable code embedded in the image data and determining, based on the machine-readable code, one or more tracking metrics associated with sharing the image data with a user of a receiving client application on a computing device.

In one example, a method for utilizing machine-readable code in image data for tracking data sharing may include (1) receiving, by a target computing device from a source computing device, image data in a graphical user interface, (2) identifying, by the target computing device, machine-readable code embedded in the image data, and (3) determining, by the target computing device, based on the embedded machine-readable code, one or more tracking metrics associated with sharing the image data.

In some examples, the image data may include a screenshot of an image displayed on the source computing device. In some examples, the machine-readable code embedded in the image data may include a barcode, such as a QUICK RESPONSE (QR) code. In other examples, the machine-readable code embedded in the image data may include an image file.

In some examples, the target computing device may determine the one or more tracking metrics by determining that a user has viewed the image data in the graphical user interface. In some examples, the method for utilizing machine-readable code in image data for tracking data sharing may further include sending the one or more tracking metrics to a tracking server.

In addition, a corresponding system for utilizing machine-readable code in image data for tracking data sharing may include several modules stored in memory, including (1) a receiving module that receives, from a source computing device, image data in a graphical user interface displayed on a target computing device, (2) an identification module that identifies machine-readable code embedded in the image data, (3) a determination module that determines, based on the embedded machine-readable code, one or more tracking metrics associated with sharing the image data, and (4) at least one physical processor configured to execute the receiving module, the identification module, and the determination module.

In some examples, the receiving module may receive the image data by receiving a screen shot of an image displayed on the source computing device. In some examples, the machine-readable code embedded in the image data may include a barcode, such as a QR code. In other examples, the machine-readable code embedded in the image data may include an image file.

In some examples, the determination module may determine the one or more tracking metrics by determining that a user has viewed the image data in the graphical user interface. In some examples, the system may further include a sending module that sends the one or more tracking metrics to a tracking server.

In some examples, the above-described method may be encoded as computer-readable instructions on a computer-readable medium. For example, a computer-readable medium may include one or more computer-executable instructions that, when executed by at least one processor of a computing device, may cause the computing device to (1) receive, from a source computing device, image data in a graphical user interface, (2) identify machine-readable code embedded in the image data, and (3) determine, based on the embedded machine-readable code, one or more tracking metrics associated with sharing the image data in the graphical user interface.

In some examples, the computer-executable instructions may cause the computing device to receive the image data by receiving a screenshot of an image displayed on the source computing device. In some examples, the machine-readable code embedded in the image data may include a barcode, such as a QR code. In other examples, the machine-readable code embedded in the image data may include an image file.

In some examples, the computer-executable instructions may cause the computing device to determine, based on the embedded machine-readable code, one or more tracking metrics associated with sharing the image data by determining that a user has viewed the image data in the graphical user interface.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for utilizing machine-readable code in image data for tracking data sharing.

FIG. 2 is a block diagram of another exemplary system for utilizing machine-readable code in image data for tracking data sharing.

FIG. 3 is a block diagram of another exemplary system for utilizing machine-readable code in image data for tracking data sharing.

FIG. 4 is a flow diagram of an exemplary method for utilizing machine-readable code in image data for tracking data sharing.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to utilizing machine-readable code in image data for tracking data sharing. As will be explained in greater detail below, embodiments of the instant disclosure may provide a client application on a computing device that may be configured to receive a screenshot of an image having embedded machine-readable code (such as a QR code) in a graphical user interface. The client application may then identify the machine-readable code and determine tracking metrics associated with the screenshot such as whether the screenshot has been shared by a user of another computing device for viewing in the client application.

The disclosed systems and methods may provide one or more advantages over traditional methods for tracking metrics for ad images shared between users of client applications, which may include applications for users of social media and social networking, image sharing, and/or instant messaging services, as a potential indicator of a viral marketing campaign. In traditional systems, if an ad is shared with another user of a client application, the receiving client application or an external server application may need to execute external program code (e.g., via an application plug-in) to determine various metrics such as whether the ad has been shared with a user of the receiving client application. This approach may incur a resource cost in the form of increased processing and memory resources for a client computing device and/or a server utilized to execute the external code needed to determine various ad metrics. Using the disclosed systems and methods, ad images may have previously embedded machine-readable code such that a client application receiving a screenshot of an ad image from a sending client application may determine an ad metric (such as the sharing of the ad) by identifying the machine-readable code embedded therein. For example, a QR code embedded in a screenshot of an ad image may be identified by a receiving client application after a message containing the screenshot is received and displayed in a graphical user interface generated by the receiving client application on a client computing device.

Thus, the disclosed systems and methods may improve the functioning of a client computing device by reducing processing and memory resources needed for determining ad metrics, such as whether an ad has been shared with multiple computing devices, thereby eliminating the need for executing external program code on a client and/or server computer. Embodiments of the instant disclosure may also provide a variety of other features and advantages over traditional systems, as explained in the following description of the accompanying figures.

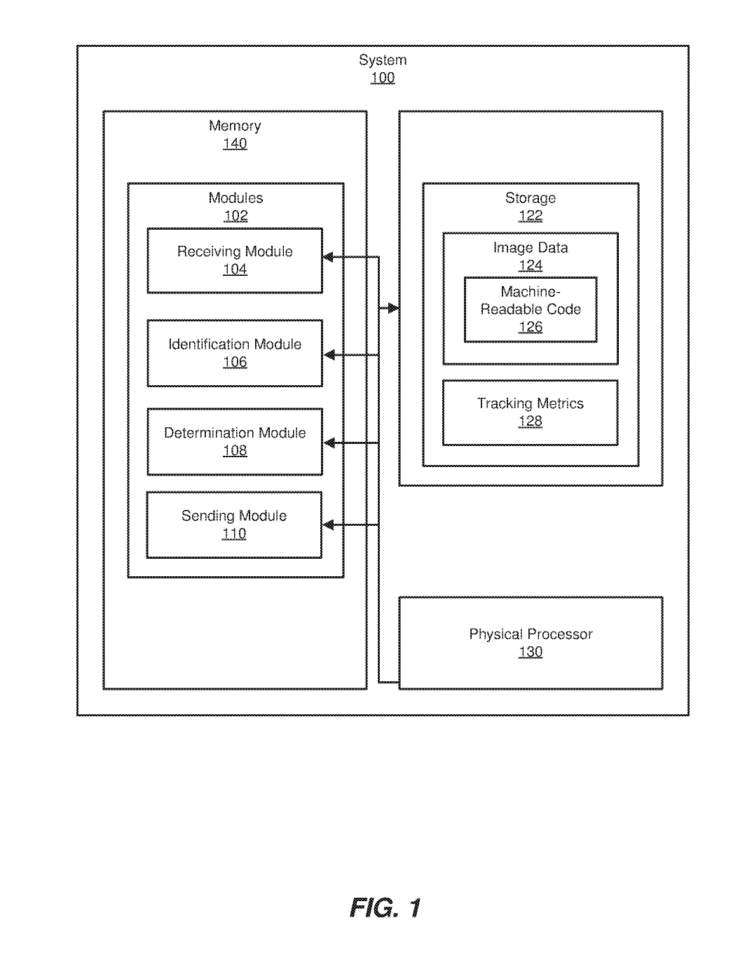

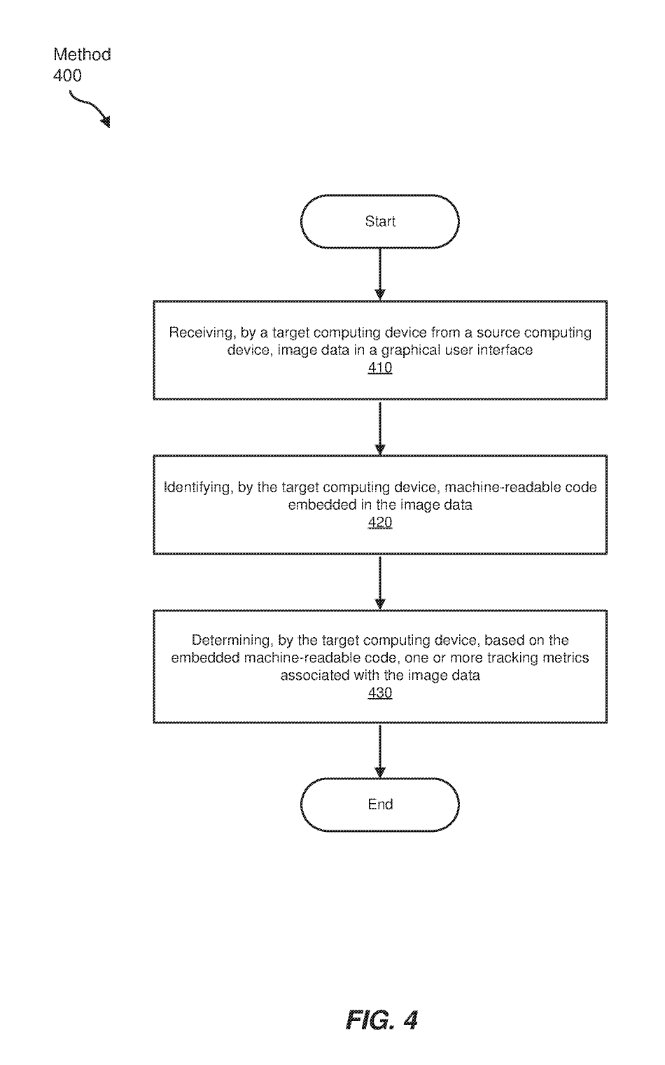

The following will provide, with reference to FIGS. 1-3, detailed descriptions of example systems for utilizing machine-readable code in image data for tracking data sharing. Detailed descriptions of a corresponding computer-implemented method will also be provided in connection with FIG. 4.

FIG. 1 is a block diagram of an example system 100 for utilizing machine-readable code in image data for tracking data sharing. As illustrated in this figure, example system 100 may include one or more modules 102 for performing one or more tasks. As will be explained in greater detail below, modules 102 may include a receiving module 104 that receives image data 124 shared from a source computing device. Example system 100 may also include an identification module 106 that identifies machine-readable code 126 embedded in image data 124. Example system 100 may further include a determination module 108 that determines, based on the embedded machine-readable code 126, one or more tracking metrics 128 associated with sharing image data 124. Example system 100 may further include a sending module 110 that sends tracking metrics 128 to a tracking server. Although illustrated as separate elements, one or more of modules 102 in FIG. 1 may represent portions of a single module or application.

The term “machine-readable code” may generally refer to data stored in a format capable of being read by a mechanical, optical, and/or electrical device. For example, machine-readable code may include identification information about an advertisement that is capable of being read by imaging software executing on a computing device. In some examples, machine-readable code may be utilized for product tracking, item identification, and/or general marketing. In one example, machine-readable code may include a barcode embedded within image data (e.g., an advertisement), such as a QR code, that utilizes standardized encoding modes (e.g., numeric, alphanumeric, byte/binary, and kanji) to efficiently store data. In other examples, machine-readable code may include an image file or a video file, embedded within image data.

The term “tracking metric” may generally refer to a measure of engagement that a user may have with content received by a client application on a social media network. For example, each time a unique user views an advertisement shared by another user on a social media network, a metric associated with the viewing of the advertisement may be logged by the receiving client application. After a tracking metric for a piece of content has been logged, it may be sent to a remote server configured to track a total number of unique user views associated with the content over a predetermined period (e.g., a day, a week, a month, etc.).

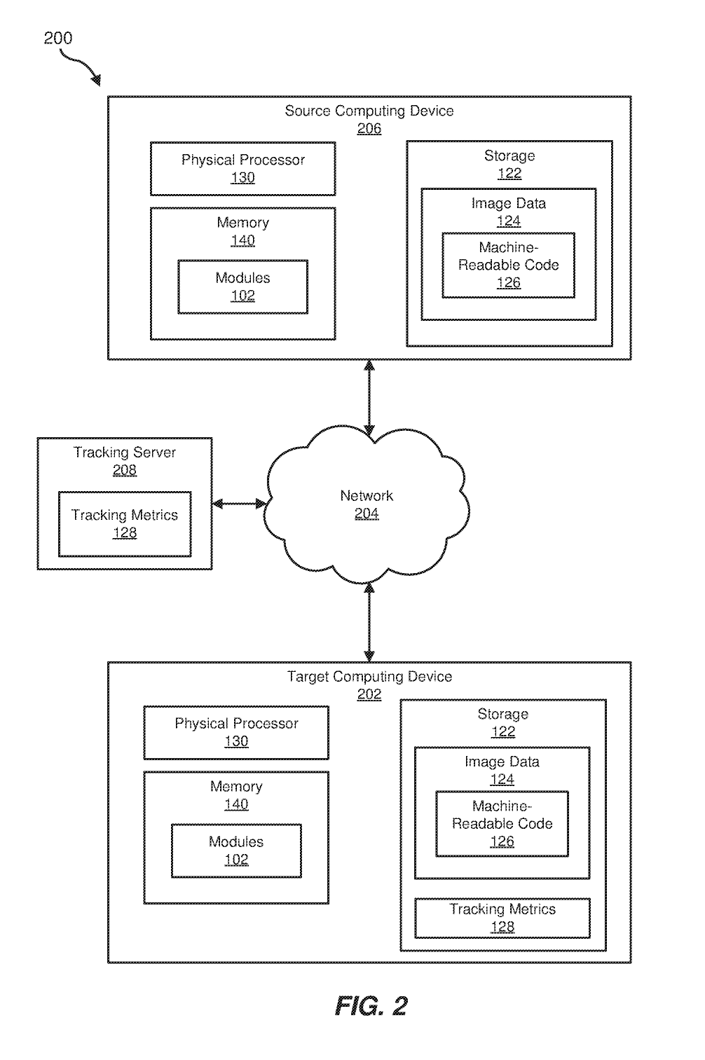

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., target computing device 202, source computing device 206, and/or tracking server 208). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 104 to facilitate utilizing machine-readable code in image data for tracking data sharing. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, system 100 may also include storage 122 that stores image data 124, machine-readable code 126, and tracking metrics 128. As will be described in greater detail below, modules 102 may be utilized to determine, based on machine-readable code 126 embedded in image data 124, one or more tracking metrics associated with the sharing of image data 124 from a source computing device, thereby reducing or eliminating the need to execute external program code for tracking metrics on a client and/or server computer.

Example system 100 in FIG. 1 may be implemented in a variety of ways. For example, all or a portion of example system 100 may represent portions of example system 200 in FIG. 2. As shown in FIG. 2, system 200 may include a target computing device 202 in communication with a source computing device 206 and a tracking server 208 via a network 204. In one example, all or a portion of the functionality of modules 102 may be performed by target computing device 202, source computing device 206, tracking server 208, and/or any other suitable computing system. As will be described in greater detail below, one or more of modules 102 from FIG. 1 may, when executed by at least one processor of target computing device 202, enable target computing device 202 to transform network resources. For example, and as will be described in greater detail below, one or more of modules 102 may cause target computing device 202 to (1) receive, from a source computing device 206, image data 124 in a graphical user interface displayed on target computing device 202, (2) identify machine-readable code 126 embedded in image data 124, and (3) determine, based on embedded machine-readable code 126, one or more tracking metrics 128 associated with source computing device 206 sharing image data 124 with target computing device 202.

Target computing device 202 and source computing device 206 may generally represent any type or form of computing device capable of reading computer-executable instructions. For example, target computing device 202 and source computing device 206 may include computing devices capable of establishing connections with a remote server (e.g., tracking server 208) to send and receive data over one or more networks.

Additional examples of target computing device 202 and source computing device 206 may include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Tracking server 208 may generally represent any type or form of computing device capable of reading computer-executable instructions. For example, tracking server 208 may be a remote server capable of establishing connections with client computing devices (e.g., target computing device 202 and source computing device 206) to facilitate target computing device 202 sending tracking metrics 128 for image data 124 shared by source computing device 206 over one or more networks. Additional examples of tracking server 208 include, without limitation, security servers, application servers, storage servers, and/or database servers configured to run certain software applications and/or provide various security, web, storage, and/or database services. Although illustrated as a single entity in FIG. 2, tracking server 208 may include and/or represent a plurality of servers that work and/or operate in conjunction with one another.

Network 204 generally represents any medium or architecture capable of facilitating communication or data transfer. In one example, network 204 may facilitate communication between target computing device 202, source computing device 206, and server 208. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

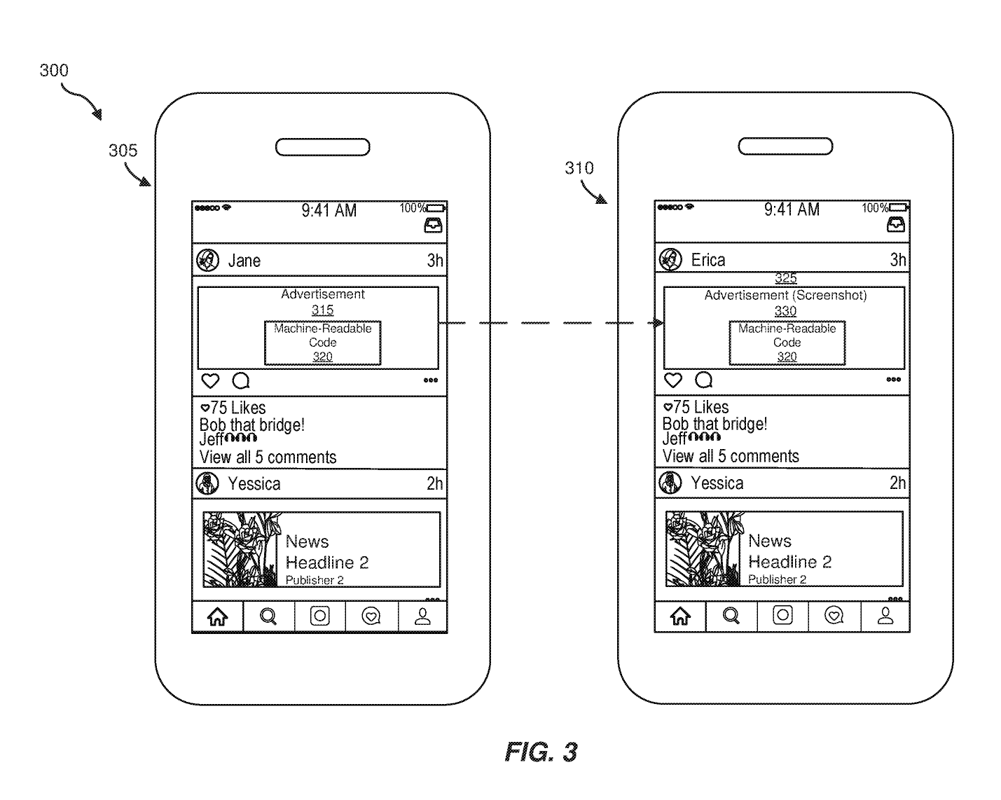

All or a portion of example systems 100 and 200 may also represent portions of example system 300 in FIG. 3. As shown in FIG. 3, system 300 may include a source computing device 305 in communication with a target computing device 310. In this example, target computing device 310 may be configured to utilize modules 102 to receive an image (e.g., advertisement 315) as a screenshot (e.g., advertisement screenshot 330) from source computing device 305 in a graphical user interface 325.

In one example, target computing device 310 may receive advertisement screenshot 330 within a message posted by a user of source computing device 305 in graphical user interface 325 as a means of sharing advertisement 315. In this example, advertisement 315 on source computing device 305 may include embedded machine-readable code 320 that is also included in the advertisement screenshot 330 received by target computing device 310.

In some examples, target computing device 310 may utilize modules 102, after receiving advertisement screenshot 330 in graphical user interface 325, to identify embedded machine-readable code 320 and determine, based on embedded machine-readable code 320, one or more tracking metrics associated with the sharing of the advertisement screenshot 330. For example, determination module 108 may determine a metric that advertisement 315 has been shared based on the presence of embedded machine-readable code 320 in advertisement screenshot 330 and the viewing of advertisement screenshot 330 by a user of target computing device 310. In one example, determination module 108 may determine that advertisement screenshot 330 has been viewed by opening a message containing advertisement screenshot 330 in graphical user interface 325.

After determining a metric that advertisement 315 has been shared in advertisement screenshot 330 based on the presence of embedded machine-readable code 320, target computing device 310 may utilize modules 102 to send the metric to a tracking server. Thus, by utilizing the embedded machine-readable code 320, processing and memory resources needed for determining ad metrics, such as whether an ad has been shared with multiple computing devices, are reduced thereby eliminating the need for executing external program code on target computing device 310.

FIG. 4 is a flow diagram of an example computer-implemented method 400 for utilizing machine-readable code in image data for tracking data sharing. The steps shown in FIG. 4 may be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 4 may represent an algorithm whose structure includes and/or is represented by multiple sub-steps, examples of which will be provided in greater detail below.

As illustrated in FIG. 4, at step 410 one or more of the systems described herein may receive, by a target computing device from a source computing device, image data in a graphical user interface. For example, receiving module 104 on target computing device 202 in FIG. 2, may receive image data 124 from source computing device 206. Image data 124 may also include embedded machine-readable code 126.

Receiving module 104 may receive image data 124 in a variety of ways. For example, receiving module 104 may receive image data 124 as a screenshot of an image displayed on source computing device 206. For example, a user of source computing device 206 wishing to share an image of content (e.g., an advertisement) displayed in a social media and social networking application may take a screenshot of the image and send it to a user of target computing device 202 where it may be received as image data 124 in a graphical user interface of the same or a similar social media and social networking application. In some examples, image data 124 may be sent as a message posted to a social media and social networking platform subscribed to by users of source computing device 206 and target computing device 202.

At step 420 in FIG. 4, one or more of the systems described herein may identify, by the target computing device, machine-readable code embedded in the image data received at step 410. For example, identification module 106 on target computing device 202 may identify machine-readable code 126 embedded in image data 124.

Identification module 106 may identify embedded machine-readable code 126 in a variety of ways. In one example, identification module 106 may identify a barcode in image data 124. For example, image data 124 may be a screenshot of an image of content (e.g., an advertisement) and may also include a barcode as machine-readable code 126. In this example, the barcode, when read, may include information identifying a screenshot of the image as the content (e.g., an advertisement) received from source computing device 206. In this example, the barcode may be a QR code. In other examples, identification module 106 may identify an image file or a video file, included in image data 124, as machine-readable code 126. In this example, the embedded image or video file may include information identifying a screenshot of the image as the content (e.g., an advertisement) received from source computing device 206.

At step 430 in FIG. 4, one or more of the systems described herein may determine, by the target computing device, based on the embedded machine-readable code identified at step 420, one or more tracking metrics associated with sharing the image data received at step 410. In one example, determination module 108 may determine, based on embedded machine-readable code 126, one or more tracking metrics associated with the sharing of image data 124 by source computing device 206.

Determination module 108 may determine the one or more tracking metrics in a variety of ways. In one example, determination module 108 may determine that a user of target computing device 202 has viewed image data 124. For example, determination module 108 may determine that a message containing a screenshot of an image (including embedded machine-readable code 126) received from source computing device 206 has been opened for viewing on target computing device 202. As another example, determination module 108 may determine that a user of target computing device 202 has viewed image data 124 by detecting that a user has scrolled through a news feed on a social media site in which the image data 124 appears.

The determination module 108 may then, based on the screenshot being viewed and the presence of the machine-readable code, determine that the screenshot has been shared by a user of source computing device 206 with a user of target computing device 202. In one example, the message may include a screenshot of an advertisement with a QR code, that has been received from source computing device 206 and opened by a user of target computing device 202.

Following the determination, by determination module 108, of one or more tracking metrics associated with the sharing of image data 124 by source computing device 206, the systems described herein may send the one or more tracking metrics to tracking server 208. In some examples, tracking server 208 may be configured to collect metrics, such as a number of shares of advertising content, for determining one or more elements of a viral marketing campaign. In one example, tracking server 208 may be configured to utilize the collected metrics to automatically update users viewing an advertising in a marketing campaign by providing new and/or additional advertising to source computing device 206 and target computing device 202.

As explained above in connection with FIGS. 1-4, one or more of the methods and/or systems described herein may enable a computing device to track the viewing of image data (such as ad impressions) shared between client applications on different computing devices without utilizing an external tracking application (e.g., a plug-in). The computing device may be configured to receive image data as a screenshot in a graphical user interface from another user (e.g., a source computing device), identify machine-readable code embedded in the image data, and determine, based on the machine-readable code, one or more tracking metrics associated with sharing the image data with a user of the computing device. In some examples, the machine-readable code may be a QR code which the computing device may identify to determine that a screenshot of an advertisement has been shared from another computing device. Thus, various metrics (such as user ad views) may be tracked by only utilizing the embedded machine-readable code in the screenshot.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data, output a result of the transformation to identify machine-readable code embedded in the image data, and use the result of the transformation to determine one or more tracking metrics associated with sharing the image data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a target computing device from a source computing device, image data in a graphical user interface;
identifying, by the target computing device, machine-readable code embedded in the image data; and
determining, by the target computing device, based on the embedded machine-readable code, one or more tracking metrics associated with sharing the image data.

2. The computer-implemented method of claim 1, wherein receiving, by a target computing device from a source computing device, image data in a graphical user interface comprises receiving a screenshot of an image displayed on the source computing device.

3. The computer-implemented method of claim 1, wherein identifying, by the target computing device, machine-readable code embedded in the image data comprises identifying a barcode embedded in the image data.

4. The computer-implemented method of claim 3, wherein the barcode comprises a QUICK RESPONSE (QR) code.

5. The computer-implemented method of claim 1, wherein identifying, by the target computing device, machine-readable code embedded in the image data comprises identifying an image file embedded in the image data.

6. The computer-implemented method of claim 1, wherein determining by the target computing device, based on the embedded machine-readable code, one or more tracking metrics associated with sharing the image data comprises determining that a user has viewed the image data in the graphical user interface.

7. The computer-implemented method of claim 1, further comprising sending the one or more tracking metrics to a tracking server.

8. A system comprising:
a receiving module that receives, from a source computing device, image data in a graphical user interface displayed on a target computing device;
an identification module that identifies machine-readable code embedded in the image data;
a determination module that determines, based on the embedded machine-readable code, one or more tracking metrics associated with sharing the image data; and
at least one physical processor configured to execute the receiving module, the identification module, and the determination module.

9. The system of claim 8, wherein the receiving module receives the image data in the graphical user interface on the target computing device by receiving a screenshot of an image displayed on the source computing device.

10. The system of claim 8, wherein the identification module identifies the machine-readable code embedded in the image data by identifying a barcode embedded in the image data.

11. The system of claim 10, wherein the barcode comprises a QUICK RESPONSE (QR) code.

12. The system of claim 8, wherein the identification module identifies the machine-readable code embedded in the image data by identifying an image file embedded in the image data.

13. The system of claim 8, wherein the determination module determines, based on the embedded machine-readable code, one or more tracking metrics associated with sharing the image data by determining that a user has viewed the image data in the graphical user interface.

14. The system of claim 8, further comprising a sending module that sends the one or more tracking metrics from the target computing device to a tracking server.

15. A computer-readable medium comprising:
computer-executable instructions that, when executed by a physical processor of a computing device, cause the computing device to:
receive, in a graphical user interface, image data from a source computing device;
identify machine-readable code embedded in the image data; and
determine, based on the embedded machine-readable code, one or more tracking metrics associated with sharing the image data.

16. The computer-readable medium of claim 15, wherein the computer-executable instructions cause the computing device to receive the image data in the graphical user interface by receiving a screenshot of an image displayed on the source computing device.

17. The computer-readable medium of claim 15, wherein the computer-executable instructions cause the target computing device to identify the machine-readable code embedded in the image data by identifying a barcode embedded in the image data.

18. The computer-readable medium of claim 17, wherein the barcode comprises a QUICK RESPONSE (QR) code.

19. The computer-readable medium of claim 15, wherein the computer-executable instructions cause the target computing device to identify the machine-readable code embedded in the image data by identifying an image file embedded in the image data.

20. The computer-readable medium of claim 15, wherein the computer-executable instructions cause the target computing device to determine, based on the embedded machine-readable code, one or more tracking metrics associated with sharing the image data by determining that a user has viewed the image data in the graphical user interface.
